(19) United States
(12) Patent Application Publication
(10) Pub. No.: US 2018/0022453 A1
(43) Pub. Date: Jan. 25, 2018

(54) Flying machine and flying unit

(71) Applicant: Haoxiang Electric Energy (Kunshan) Co., Ltd., Kunshan (CN)

(72) Inventors: Yu Tian, Kunshan (CN); Wenyan Jiang, Kunshan (CN)

(73) Assignee: Haoxiang Electric Energy (Kunshan) Co., Ltd.

(21) Appl. No.: 15/698,641

(22) Filed: Sep. 8, 2017

(30) Foreign Application Priority Data
Dec. 31, 2016 (CN) 201611267554.3
Dec. 31, 2016 (CN) 201621485789.5
Dec. 31, 2016 (CN) 201621485799.9
Dec. 31, 2016 (CN) 201621485818.8
Dec. 31, 2016 (CN) 201621485829.6
Dec. 31, 2016 (CN) 201621485831.3
Dec. 31, 2016 (CN) 201720007096.3

(51) Int. Cl. B64C 39/02; B64D 47/08

(52) U.S. Cl. CPC B64C 39/024; B64D 47/08; B64C 2201/108; B64C 2201/162; B64C 2201/127

(57) ABSTRACT

A flying machine disclosed in the present application includes a main body, a flying module and a function module which is for controlling working state of the flying module. The flying module includes at least one pair of flying units, wherein the flying unit includes a flying frame, rotors and a steering oar which works with the rotors to propel the flying machine. Compared with the conventional flying machine which requires four rotors, while loaded with the same power source, the present flying machine doubles the flight time, which solve the problem of short working time.

### CROSS REFERENCE OF RELATED APPLICATION

The present invention claims priority under 35 U.S.C. 119(a-d) to CN 201611267554.3, filed Dec. 31, 2016; CN 201720007096.3, filed Dec. 31, 2016; CN 201621485831.3, filed Dec. 31, 2016; CN 201621485799.9, filed December 31; CN 201621485789.5, filed Dec. 31, 2016; CN 201621485818.8, filed Dec. 31, 2016 and CN 201621485829.6, filed Dec. 31, 2016.

### BACKGROUND OF THE PRESENT INVENTION

### Field of Invention

The present invention relates to the flying machine and the flying unit adopted by the flying machine

### Description of Related Arts

The conventional flying machine is categorized as fixed-wing flying machine, helicopter and multi-rotor flying machine.

The fixed-wing flying machine requires open field, such as a special runway or special area.

The main rotor is for lifting the helicopter. The tail rotor is for anti-torque caused by the main rotor while providing the lift. The driver tilts the main rotor by operating the joystick, which tilts the pull direction of the main rotor and further moves the helicopter forward, backward and sideward. The instrument of the helicopter is difficult to control.

The multi-rotor flying machine conventionally possesses four rotors which are distributed in the front, rear, left and right side of the machine body symmetrically. The four rotors are positioned in the same level height, the structures and radius of which are same. The four rotor motors are settled at the supporting frame ends symmetrically. The flight control computer and the external devices are placed at the center of the supporting frame.

The four-rotor flying machine adjusts the rotation speed of the rotor by adjusting the rotation speed of the four motors to change the lift and control the posture and position of the flying machine.

The motion states of the four-rotor flying machine are as follow:

Vertical Motion:

Referring to the FIG. 1, increasing the power output of the four motors at the same time to speed up the rotation of the rotor and increase the total pull force. When the total pull force is strong enough to overcome the machine weight, the four-rotor flying machine is lifted vertically from the ground; or, decreasing the power output of the four motors at same time to vertically lower down the four-rotor flying machine until the flying machine safely landed. The flying machine is able to vertically move along the z axis. While the external disturbance is zero and the lift of the rotors equals the own weight of the flying machine, the flying machine is hovering.

Angle of Attack Motion:

Referring to FIG. 2, the rotation speed of the motor 1 is accelerated, the rotation speed of the motor 3 is decelerated (change in the same speed magnitude) and the rotation speed of the motor 2 and motor 4 remains unchanged. The lift of the rotor 1 is increased while the lift of the rotor 3 is decreased, which generates an unbalanced torque to rotate the machine around y axis. Similarly, when the rotation speed of the motor 1 is decelerated and the rotation speed of the motor 3 is accelerated, the machine rotates around the y axis in a counter direction to realize the angle of attack motion. The rotation around x axis is similar to the rotation around the y axis and no further explanation is needed.

Yaw Motion:

A counter torque is generated, which is reverse to the rotation direction due to the air resistance caused by the rotation of the rotor. In order to overcome the counter torque, two rotors are set to rotate clockwise and the other two rotors are set to rotate counter clockwise. The rotors on the same diagonal line rotate in the same direction. The magnitude of the torque relates to the speed magnitude of the rotors. When the four motors rotate at the same speed, the counter torques generated by the four rotors are balanced with each other and the four-rotor flying machine does not rotate; when the four motors rotate at different speed, the unbalanced counter torque rotates the four-rotor flying machine. Referring to the FIG. 3, when the rotation speed of the motor 1 and motor 3 is accelerated while the rotation speed of the motor 2 and motor 4 is decelerated, the counter torque caused by the rotor 1 and rotor 3 is bigger than the counter torque caused by the rotor 2 and rotor 4. The extra counter torque rotates the machine around the z axis. The flying machine yaws and rotates reversely to the rotation direction of the motor 1 and motor 3.

Horizontal Motion:

In order to move the flying machine within a horizontal level forward, backward, left and right, a force must be applied on the flying machine within the horizontal level. Referring to the FIG. 4, speeding up the rotation of the motor 3 to increase the pull force; lowering down the rotation of the motor 1 correspondingly to decrease the pull force; remaining the rotation of the other two motors unchanged; balancing the counter torque. Referring to the FIG. 2, the flying machine first tilts to a certain degree to generate a horizontal component of the pull force of the rotor and move the flying machine forward. Moving the flying machine backward, left and right is similar to moving the flying machine forward, which needs no further explanation.

The disadvantages of the conventional technology are as follow:

In order to keep running the four motors, the corresponding power is required.

The load of the flying machine is limited, which causes the working time is limited by the power loaded on the flying machine.

A flying machine which is able to work longer time is needed.

### SUMMARY OF THE PRESENT INVENTION

An object of the present invention is to provide a flying machine, comprising:

a main body;

a flying module disposed on the main body;

a function module disposed on the main body, which is for controlling working state of the flying module;

wherein the flying module comprises at least one pair of flying units;

each of the flying units comprises:

a flying frame;

rotors disposed on the flying frame;

a steering oar disposed on the flying frame, which works with the rotors to propel the flying machine.

Furthermore, the flying module comprises one pair of the flying units,

Furthermore, the flying frame comprises a circular wall;

the enclosed circular wall forms a wind tunnel in which the flying frame is contained;

the wind tunnel comprises an air outlet;

the steering oar is disposed on the air outlet.

Furthermore, a mounting axis of the steering oar runs through and along a diameter of the circular wall; the steering oar is able to rotate within the flying frame.

Furthermore, the flying machine possesses a vertical indication line to indicate a moving direction; the pair of flying units is disposed symmetrically along a horizontal direction intersecting with the vertical indication line.

Furthermore, a mounting axis of the steering oar is perpendicular to the vertical indication line.

Furthermore, the present invention provides a flying unit, comprising:

a flying frame;

rotors disposed on the flying frame;

a steering oar disposed on the flying frame, which works with the rotors to propel the flying machine.

Furthermore, the flying frame comprises a circular wall;

wherein the enclosed circular wall forms a wind tunnel in which the rotors are contained;

the wind tunnel comprises an air outlet;

the steering oar is disposed on the air outlet.

Furthermore, a mounting axis of the steering oar runs through and along a diameter of the circular wall; the steering oar is able to rotate within the flying frame.

Furthermore, a casing tube is disposed along a diameter of the flying frame, the steering oar is fixed on the casing tube, which rotates integrally with the casing tube relatively to the flying frame.

The benefits of the flying machine and flying unit provided in the present invention are at least as follow.

Compared with the conventional flying machine which requires four rotors, while loaded with the same power source, the present flying machine doubles the flight time, which solve the problem of short working time.

### BRIEF DESCRIPTION OF THE DRAWINGS

The drawings described are for better understanding of the present invention, which is part of the present invention. The embodiments are an illustration of the present invention and are not limitations.

FIG. 1 is a diagram to illustrate the vertical motion of the conventional four-rotor flying machine;

FIG. 2 is a diagram to illustrate the angle of attack motion of the conventional four-rotor flying machine;

FIG. 3 is a diagram to illustrate the yaw motion of the conventional four-rotor flying machine;

FIG. 4 is a diagram to illustrate the horizontal motion of the conventional four-rotor flying machine;

FIG. 5 is a perspective view of the structure of a flying machine provided in the present invention;

FIG. 6 is a perspective view of the flying module of the flying machine provided in the present invention;

FIG. 7 is a perspective view of the flying module of the flying machine provided in the present invention from a different angle;

FIG. 8 is a perspective view of the flying module of the flying machine provided in the present invention from a third angle.

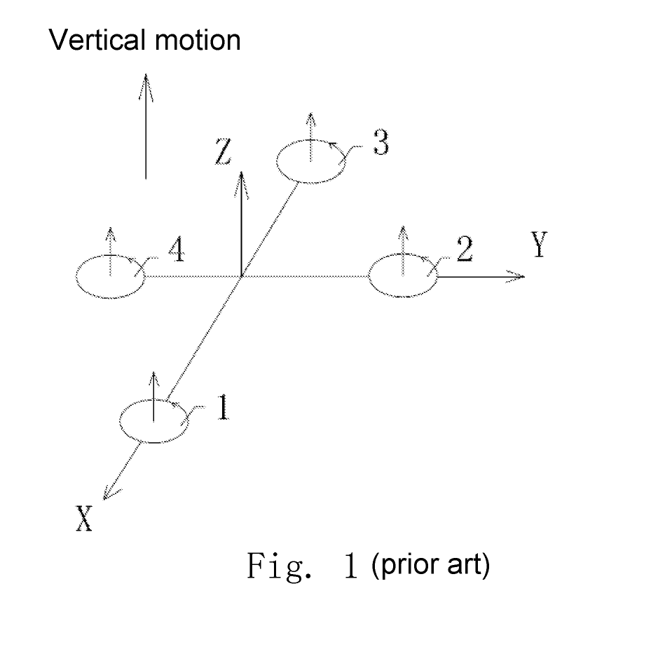

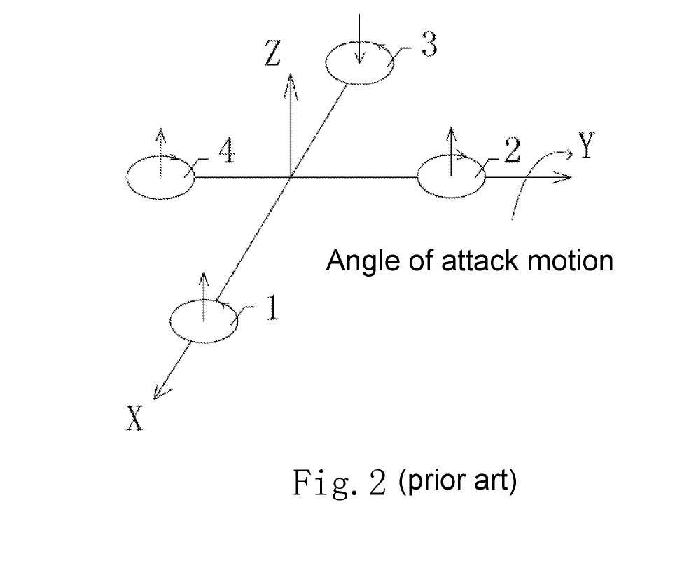

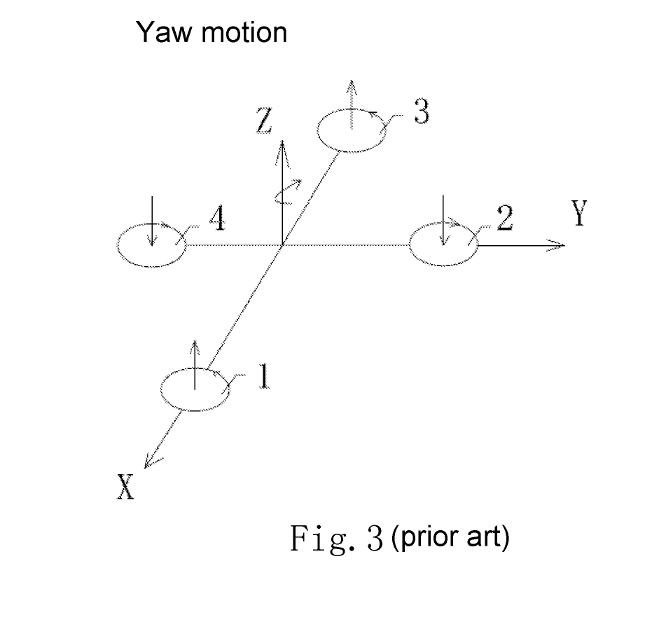

### DETAILED DESCRIPTION OF THE PREFERRED EMBODIMENT

Referring to the drawings, according to preferred embodiments of the present invention is illustrated clearly and fully. Obviously, the embodiments are just part of the embodiment of the present invention. Based on the embodiments of the present invention, the embodiments achieved by the skilled technicians in the field without innovative effort are with in the protection range of the present invention.

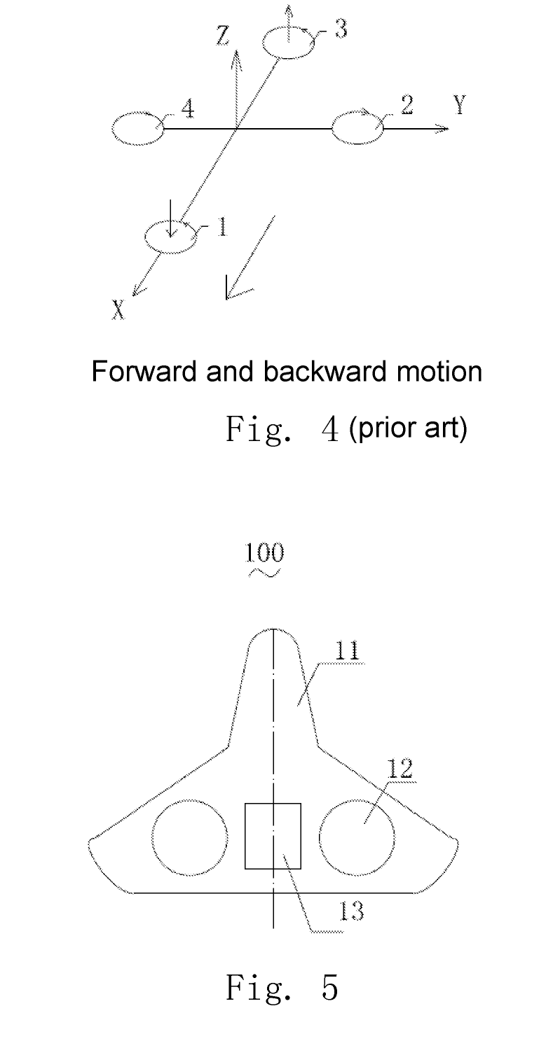

FIG. 5 is a perspective view of the flying machine 100 provided in the present invention. The flying machine 100 comprises a main body 11, flying module 12 disposed on the main body 11, a function module 13 disposed on the main body 11, which is for controlling working state of the flying module.

The flying machine 100 is usually a UAV (unmanned flying vehicles) for aerial photography, providing the virtual reality view angle or transporting lightweight articles. For a better understanding, the flying machine 100 for providing the virtual reality view is illustrated as below.

The specific applied function and appearance of the flying machine 100 is not a limitation for the present invention.

The main body 11 is for providing a frame structure for the flying machine 100, on which other devices, structures and components are settled. The main body 11 is able to provide the mounting positions for the function module 13 and the flying module 12 and protect the function module 13 and the flying module 12. The main body 11 is hollow inside to install the function module 13 and the flying module 12.

Many techniques are able to be adopted to produce the main body 11, such as injection, casting, machine cutting and etc. Integral injection molding is able to be adopted for producing the main body 11 in the embodiments of the present invention. Two halves of the main body are able to be injection molded and coupling together to form the main body 11. The special components of the main body are able to be integrally injection molded separately and assembled onto the corresponding positions on the two halves of the main body to form the whole main body 11. The external surface of the main body is able to be polished, coated and etc. to reduce the wind resistance.

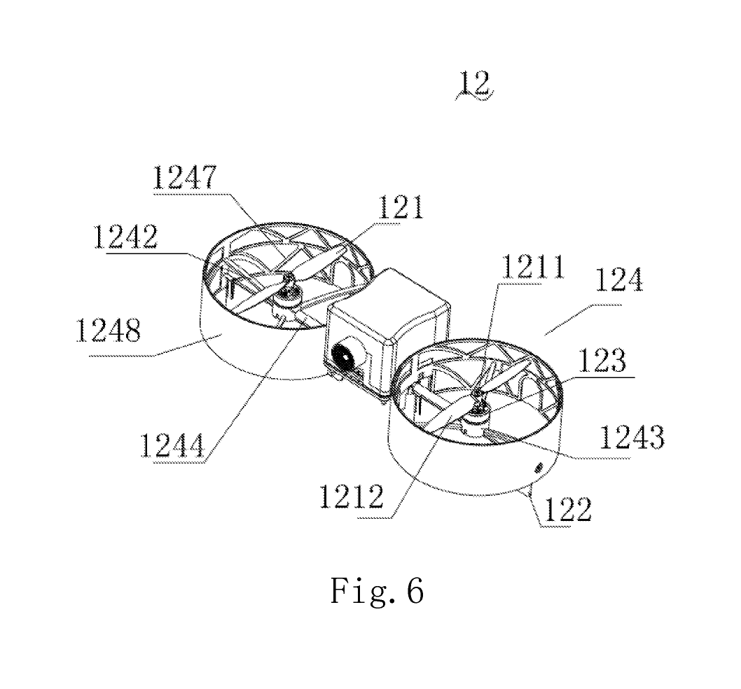

Referring to the FIG. 6, the flying module 12 provides the power for the flying machine 100. The flying module 12 in the flying machine 100 comprises a pair of rotors 121 and the steering oar 122 which works with the rotors 121. Specifically, the flying machine 100 is able to be a double-rotor flying machine which adopts only one pair of the rotors 121 and a steering oar 122 which works with the rotors 121. The flying machine 100 is also able to adopt one pair of he rotors 121 and a steering oar 122 which works with the rotors 121 as part of the power supply. Such as the double-rotor flying machine 100, the fixed-wing flying machine adopts one pair of the rotors 121 and the steering oar 122 to work with the rotors 121, the helicopter or even thermal-powered flying machine.

The diameters of the pair of rotors are able to be the same or different. For the convenience of controlling or calculation, the pair of the rotors 121 is disposed with the same diameter. The pair of rotors 121 is able to replace each other, the shape, structure and size of which is exactly the same.

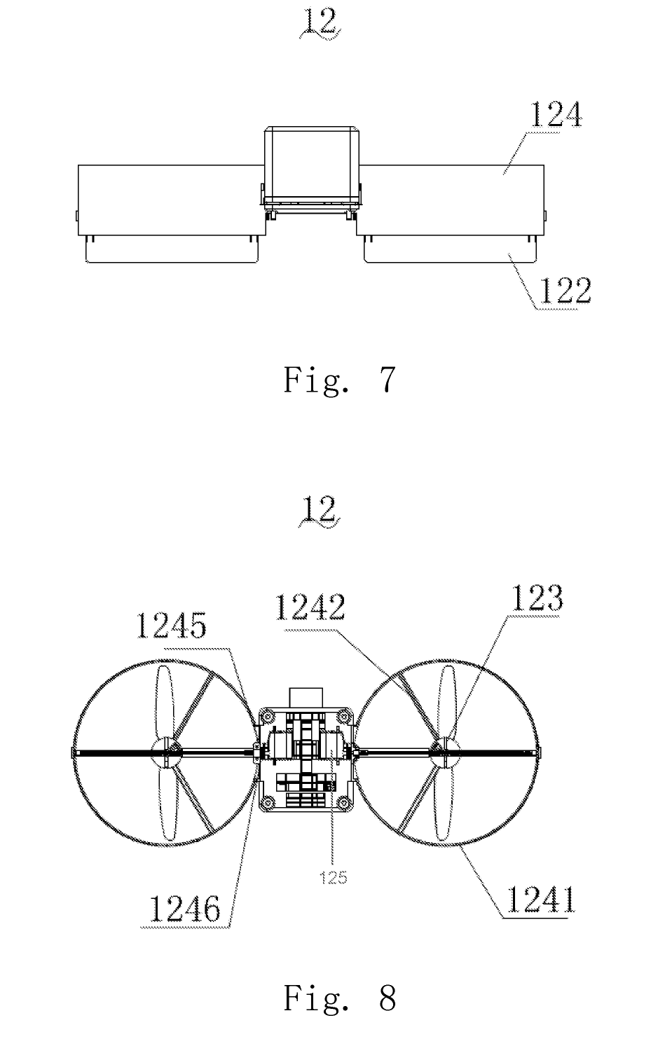

Referring to the FIG. 6 to FIG. 8, the flying module 12 comprises two flying units. Each of the flying units comprises the rotor 121, the steering oar 122, a flying frame 124, a rotor motor 123 and a steering motor 125.

The rotor 121 is able to comprise a center cylinder 1211 and blades 1212 extending outward from the center cylinder 1211. The blades 1212 tilt relatively to the axial end of the center cylinder 1211 to generate an opposite force to the air when rotates and provide an axial lift for the blade 1212. Multiple blades are able to be adopted to increase the lift. The rotor 121 is able to adopt normal plastic material and be integrally molded, or adopt fatigue-resistance light alloy and be produced by casting.

The rotor 121 is driven by the rotor motor 123. The stator or the rotor of the rotor motor 123 is mechanically fixed with the center cylinder 1211 of the rotor 121. Correspondingly, the stator or the rotor of the rotor motor 123 is mechanically fixed with the flying frame 124. The rotor motor 123 is able to drive the rotor 121 rotating relatively to the flying frame. The blade 1212 of the rotor 121 squeezes the air and an opposite force is generated to provide an axial lift for the blade 1212. The rotor motor 123 is able to adopt a normal motor or a brushless motor according to different situations.

The flying frame 124 comprises a circular wall 1241 encloses the rotor 121, stiffeners 1242 which extends from the circular wall 1241 to the center of the flying frame 124. Multiple stiffeners 1242 are collected and form a center pillar 1243. Or, setting the center pillar 1243 in the flying frame 124 and lapping the stiffeners 1242 on the center pillar 1243 to firm up the flying frame 124. The center pillar 1243 is able to be locked with the stator of the rotor motor 123. The center pillar 1243 and the rotor motor 123 share the same axis. In order to enhance the anti-impact force of the stiffener 1242, the stiffener 1242 is a curve. Specifically, one end of the stiffener 1242 is connected to the circular wall 1241 and the other end is connected to the center pillar 1243. The curved stiffener 1242 bends outward and towards the circular wall 1241. When the flying machine 100 collided, the impact force is dispersed on the stiffener 1242 and the stiffener is not able to be easily broken. In the present invention, three stiffeners 1242 are able to be distributed evenly along the circumference of the circular wall and a 120 degree angle is formed between every two stiffeners.

The steering oar 122 is disposed on the flying frame 124 and is able to rotate. A casing tube 1244 is disposed along a diameter of the flying frame 124. The steering oar 122 is fixed on the casing tube 1244, which rotates integrally with the casing tube 1244 relatively to the flying frame 124. The steering oar 122 and the casing tube 1244 are able to be integrally molded or produced separately and then fixed on the casing tube 1244 by ways such as welding and bonding. The carbon fiber is able to be adopted to strengthen the casing tube 1244. The carbon fiber tube is hollow, inside which is the current traverse. The current traverse which provides the power to the rotor motor 123 is inside the casing tube 1244. An opening is cut in the middle of the casing tube 1244, from which the current traverse is led out to electrically connect to the rotor motor 123 and provide the power to the rotor motor 123.

The steering oar 122 is driven by the steering oar 125. In the embodiment of the present invention, the casing tube 1244 is able to coupling with the first gear. The steering motor 125 is coupling with the second gear 1246. The first gear 1245 clenches with the second gear 1246. The steering oar 122 is thus able to be driven by the steering motor 125.

The lift of the flying unit is able to be provided by the rotor 121 and the propelling force of the flying unit is able to be provided by the rotor 121 and the steering oar working together. Tests and experiments are required for designing acceptable flying unit. The depth of the flying frame induces different performances of the flying unit. Specifically, the space enclosed by the circular wall 1241 of the flying frame 124 is normally known as the wind tunnel or the culvert. The depth of the wind tunnel or the culvert affects the flying performance t of the flying machine 100. The enclosing space of the flying frame 124 is called the wind tunnel collectively. In order to test the influence of the wind tunnel depth on the flying machine 100, circular walls 1241 of different depth are required. The corresponding molds are designed and the circular walls 1241 with different depth are produced by injection molding. A preferable embodiment is provided in the present invention to cut the test and experiment cost, in which the flying frame 124 comprises a circular wall 1241 and a vault which lies in the middle of the circular wall 1241. A stiffener 1242 is disposed between the circular wall 1241 and the vault, wherein multiple extension arms 1247 extends along the axial of the circular wall 1241. The flying frame further comprises the coating film 1248 which covers the extension arms 1247 to form an extension wall. The extension wall extends the axial depth of the flying unit and enlarges the wind tunnel, which requires no new design, molding and manufacture for the circular wall 1241 with new depth. Thus the efficiency of the test and experiment for the flying unit is improved and the cost for the test and experiment is reduced.

Furthermore, in a preferred embodiment of the present invention, multiple axial positioning structures are disposed along the axis of the extension arm 1247; wherein the coating film 1248 possesses a series of customized depth to correspond the axial positioning structures.

Furthermore, in the preferred embodiment of the present invention the axial positioning structures are raised blocks which fit the pre-set axial spacing.

Specifically, a raised block is disposed every 5 mm along the axial extending direction of the extension 1247. A series of customized axial depth of 5 mm, 10 mm and 15 mm is able to be set by the coating film 1248. When a 5 mm is required to extend along the axial depth of the circular wall 1241, the coating film with the axial depth of 5 mm is chosen to cover the extension arm 1247. Similarly, when a 15 mm is required to extend along the axial depth of the circular wall 1241, the coating film with the axial depth of 15 mm is chosen to cover the extension arm 1247. The coating film 1248 is limited by the axial positioning structures according to the design.

Furthermore, in a preferred embodiment of the present invention, the multiple extension arms form an outer diameter of the flying frame 124. The outer diameter is increasing along the assembling direction of the coating film 1248. For the convenience of coating the film 1248, the assembling is start from the side of the flying frame with small outer diameter. The coating film is dragged towards the side of the flying frame with bigger outer diameter to complete the assembling.

Furthermore, in a preferred embodiment of the present invention, the multiple extension arms 1247 are parallel with each other and are distributed in a cylinder shaped space.

For better understanding, the multiple rod shaped suspension arms are disposed along the axis of circular wall 1241 as the extension arm 1247. Each extension arm 1247 is parallel with the bus bar of the circular wall 1241. Thus the molding design of the flying frame 124 is simple, which is able to cut the cost.

Furthermore, in a preferred embodiment of the present invention, the extension arms 1247 are disposed in pairs. The cross section of the pair of the extension arm 1247 is distributed on the two ends of the circumference diameter.

For a better understanding, the extension arm 1247 is able to be a curved rod. The curved rod is able to extend longer than the straight rod on the external wall of the flying frame 124, which is able to improve the impact resistance capability of the extension arm 1247 and extend the service life of flying frame 124.

Furthermore, in a preferred embodiment of the present invention, the flying frame comprises a circular wall;

Multiple plugholes are disposed on the end face of the circular wall;

The flying frame comprises multiple extension arms;

The extension arms are plugged into the plugholes;

The coating film covers the extension arm to form an extension wall;

The circular wall and the extension wall enclosed to form the wind tunnel.

For a better understanding, the extension arms 1247 and the circular wall 1241 are integral while in the embodiment the circular wall 1241 and the extension arm 1247 are separated. Multiple plugholes are distributed along the circumference diameter of the end face of the circular wall 1241 and the extension arms 1247 are plugged into the plug holes.

Furthermore, in a preferable embodiment of the present invention, the extension arms possess a series of customized lengths. The coating film possesses a series of customized axial depth which corresponds to the customized length of the extension arm.

The length of the extension arm 1247 inside the plug hole is able to be customized according to the requirement. The axial depth of the coating film 1248 is able to be customized accordingly. For example, the length of the extension arm 1247 is 15 mm and correspondingly the axial depth of the coating film 1248 is 15 mm.

The two flying units of the flying module 12 are disposed symmetrically on the main body 11. The steering motor 125 is disposed in the middle. In the embodiment of the present invention, the function module 12 is disposed in the middle of the two flying units to reduce the size of the flying machine 100.

An avoid-space is disposed between the main body 11 of the flying machine 100 and the flying units. When the flying machine 100 is collided, the main body 11 is elastically deformed, part of the avoid-space of the main body which is opposite to the flying unit elastically deformed. When the elastic deformation of the main body 11 of the flying unit is bigger than the size of the avoid-space, the flying units is squeezed. Thus the flying unit is effectively protected. Furthermore, in a preferable embodiment of the present invention, the avoid-space is filled with shock absorbing material to reduce the influence of the impact on the flying unit.

The function module 13 is on one hand to control the flying machine 100 and on the other hand to complete the specific functions of the flying machine 100.

Different flying machine 100 possesses different flying control mechanism. In the embodiment of the present invention, the flying machine 100 comprises at least one pair of rotors 121. The rotor motor 123 drives the rotor 121 to rotate. The function module 13 comprises the control part of the rotor motor 123 of at least one pair of the rotors. The function module 13 at least controls the rotor motor 123 to stop and start, rotate clockwise and counter clockwise. The function module 13 is also controls the rotation speed of the rotor motor 123. The stop and start, clockwise and counter clock wise rotation and the speed of the rotor motor 123 correspond to the different rotation states of the rotor 121. The different rotation states of the rotor 121 decide the different flying states of the flying machine.

The embodiment of the present invention provides a steering oar 122 which works with the rotors 121. The steering oar 122 is able to be driven by the steering motor 125. The function module 13 comprises at least the control part of the one pair of the steering motor 125. The function module 13 at least controls the stop and start, clockwise and counter clockwise rotation and speed of the steering motor 125. The stop and start, clockwise and counter clock wise rotation and the speed of the rotor motor 125 correspond to the different rotation states of the rotor 122. The different rotation states of the rotor 122 decide the different flying states of the flying machine.

The data transmission module comprises the wireless transceiver and the antenna. The wireless transceiver is able to transmit the data by the electromagnetic wave of the wireless communication band. The WIFI electromagnetic wave of the conventional band is also able to be adopted for data transmission. For example, the 4G (fourth generation) communication signal or the 2.4 hz WIFI signal are adopted. The data transmission module is able to receive the control instructions on the flying machine 100 from the user on one hand and on the other hand feedback the flying parameters of the flying machine 100 to the user, which helps the user to control the flying machine 100 more accurately. The data transmission module is also able to feedback the parameters involved in the specific functions to the user.

The power management module is able to manage the power loaded on the flying machine 100, for example, to feedback the power remaining in time and the use of the power.

The processing module is normally a processing chip. The memory module is normally a computer memory or a cache. The serialized instruction set is normally stored in the memory module. The processing module executes the serialized instructions set to realize the functions of the function module 13. The flying control methods, the data transmission methods and the power management methods of the flying machine 100 are programmed to form the serialized instruction set which is saved in the memory module.

The function module 13 completes the specific functions of the flying machine 100 on the other hand. For a better understanding, the flying machine 100 which provides the virtual reality view angle is adopted for illustration. The flying machine 100 comprises the image collection module and the positioning module. The image collection module is able to be a camera or a video camera. The camera or the video camera transfers the collected images into the electric signals. Or, the camera or the video camera transmits the images to the processing module which transfers the images into the electric signals. The electric signals are transmitted to the user through the data transmission module. Specifically, the transmission is able to be from the user to the flying machine 100. Or the data is transmitted to the virtual reality device or the mobile terminal held by the user. The electric signals are decoded into the images monitored by the flying machine 100 for the user to view. And the flying machine 100 provides the virtual reality view angle. The positioning devices are normally an electronic gyroscope, an electronic compass and etc., which provide the spatial location of the flying machine 100. The flying machine 100 further comprises a steering module for completing the change in direction of the image collection module.

The modules in the function module 13 are set corresponding to the specific function of the flying machine 100. In the embodiment the flying machine 100 which provides the virtual reality view angle is adopted for illustration. The specific functions of the flying machine 100 are not limitations for the present invention.

The structure of the embodiment is fully described. The below is the method of the embodiment, comprising the steps of

Injection molding the flying frame 124, the rotor 121 and the steering oar 122 separately; assembling the rotor motor 123 with the rotor 121; mounting the steering oar 1122 on the flying frame 124; assembling the steering motor 125 and the steering oar 122; assembling a flying unit with a rotor 121, a steering oar 122, a flying frame 124, a rotor motor 123 and a steering motor 125; assembling a pair of the flying units as a flying module 12 on the main body 11; assembling the function module 13 on the main body 11. While the flying machine is flying, the pair of the rotors 121 is able to keep the anti-torque balancing with each other. The steering oar 122 tilts under the control of the steering motor 125; wherein the rotor 121 squeezes the air flow rushing to the steering oar 122. The air flow on the two sides of the steering oar 122 is unbalanced, which propels the flying machine 100. The two rotors in the present invention rotates for long time to generate a lift and the steering oar just works when a adjustment of the propel force is required. Compared with the conventional flying machine which requires four rotors, while loaded with the same power source, the present flying machine doubles the flight time, which solve the problem of short working time.

The embodiments are not a limitation for the present invention. For a skilled technician in the field, alterations and modifications of the present invention are possible to be carried out. Any alterations, replacements and modifications within the spirit and strategy of the present invention are within the protection range of the present invention.

What is claimed is:

1. A flying apparatus, comprising:
a main body;
a flying module disposed on the body; and
a function module disposed on the main body, which is configured to control a working state of the flying module;
wherein the flying module comprises at least one pair of flying units;
each of the flying units comprises:
a flying frame;
to rotors disposed on the flying frame;
a steer disposed on the flying frame, which is configured to work with the rotors to propel the flying apparatus.

2. The flying machine, as recited in claim 1, wherein the flying module comprises one pair of the flying units.

3. The flying machine, as recited in claim 2, wherein the flying frame comprises a circular wall;
wherein the circular wall, which is enclosed, forms a wind tunnel in which the flying frame is contained;
the wind tunnel comprises an air outlet;
the steering oar is disposed on the air outlet.

4. The flying machine, as recited in claim 3, wherein a mounting axis of the steering oar runs through and along a diameter of the circular wall; the steering oar is rotatable within the flying frame.

5. The flying machine, as recited in claim 4, wherein the flying machine has a vertical indication line to indicate a moving direction; the pair of the flying units are disposed symmetrically along a horizontal direction intersecting with the vertical indication line.

6. The flying machine, as recited in claim 5, wherein a mounting axis of the steering oar is perpendicular to the vertical indication line.

7. The flying unit, as recited in claim 3, wherein a mounting axis of the steering oar runs through and along a diameter of the circular wall; the steering oar is rotatable within the flying frame.

8. The flying unit, as recited in claim 7, wherein a casing tube is disposed along a diameter of the flying frame, the steering oar is fixed on the casing tube, which rotates integrally with the casing tube relative to the flying frame.

9. A flying unit for experiment, comprising:
a flying frame;
rotors disposed on the flying frame; and
a steering oar disposed on the flying frame, which cooperates with the rotors to propel the flying machine; wherein
the flying frame comprises a circular wall;
a plurality of extension arms extending on the circular wall along an axis of the circular wall; and
a coating film covers the extension arms, which forms an extension wall;
wherein the circular wall and the extension wall are enclosed to form a wind tunnel.

10. The flying unit, as recited in claim 9, wherein a plurality of axial positioning structures are disposed along an axis of the extension arms; the coating film has a series of customized axial depth corresponding to the positioning structures.

11. A strengthened flying unit, comprising:
a flying frame;
rotors disposed on the flying frame; and
a steering oar disposed on the flying frame, which cooperates with the rotors to propel the flying machine;
wherein the flying frame comprises:
a circular wall;
a center pillar disposed in an enclosed hollow part by the circular wall; and
a rod stiffener with a first end connected to the circular wall and a second end connected to the center pillar.

12. The flying unit, as recited in claim 11, wherein a vertical height of the first end of the stiffener is higher than a vertical height of the second end of the stiffener.

13. A flying machine, comprising
a main body;
a flying module disposed on the main body;
a function module on the main body, which is for controlling working state of the flying module;
wherein the flying module comprises at least one pair of flying units;
each of the flying units comprises:
a flying frame;
rotors disposed on the flying frame;
a steering oar disposed on the flying frame, which works with the rotors to propel the flying machine;
the flying frame comprises a circular wall;
wherein a casing tube is disposed along a diameter of the circular wall, the steering oar is fixed on the casing tube, which rotates integrally with the casing tube relatively to the flying frame;
wherein the casing tube is hollow inside, which is for distributing a current traverse to provide power for the rotors to rotate.

14. The flying machine, as recited in claim 13, wherein a center pillar disposed in a center part of the circular wall of the flying frame; the casing tube extends from the circular wall to the center pillar.
